(19) United States
(12) Patent Application Publication
(10) Pub. No.: US 2012/0065968 A1
(43) Pub. Date: Mar. 15, 2012

(54) SPEECH RECOGNITION METHOD

(75) Inventor: HANS-JÖRG GRUNDMANN, Berlin (DE)

(73) Assignee: SIEMENS AKTIENGESELLSCHAFT, MUENCHEN (DE)

(21) Appl. No.: 13/229,913

(22) Filed: Sep. 12, 2011

(30) Foreign Application Priority Data
Sep. 10, 2010 (DE) 10 2010 040 553.1

(51) Int. Cl. G10L 15/00

(52) U.S. Cl. 704/231; 704/E15.001

(57) ABSTRACT

In a speech recognition method, a number of audio signals are obtained from a voice input of a number of utterances of at least one speaker into a pickup system. The audio signals are examined using a speech recognition algorithm and a recognition result is obtained for each audio signal. For a reliable recognition of keywords in a conversation, it is proposed that a recognition result for at least one other audio signal is included in the examination of one of the audio signals by the speech recognition algorithm.

The invention relates to a speech recognition method in which a number of audio signals are obtained from a speech input of a number of utterances of at least one speaker into a pickup system, the audio signals are examined using a speech recognition algorithm and a recognition result is obtained for each audio signal.

In the speech recognition of entire sentences, the correct delimitation of individual words within one sentence represents a considerable problem. Whilst in written language, each word is separated from its two neighbors by a space and can thus be easily recognized, adjacent words in the spoken language blend into one another without being audibly acoustically separated from one another. Processes which enable a person to understand the sense of a spoken sentence, such as a categorization of the phonemes heard into an overall context, taking into consideration the situation in which the speaker finds himself cannot be easily performed by computer.

The uncertainties in the segmentation of a fluently spoken sentence into phonemes can become apparent in a lack of quality in the identification of presumably recognized words. Even if only single words such as keywords in a conversation are to be recognized, wrong segmentation will mislead subsequent grammatics algorithms or multi-gram-based statistics. As a consequence, the keywords will also not be recognized or only with difficulty.

The problem is aggravated by high background noise which further impair a segmentation and word recognition. So-called uncooperative speakers form a transcending problem. Whilst during a dictation into a speech recognition system, speaking is cooperative, as a rule, that is to say the speaker performs his dictation in such a manner, if possible, that the speech recognition is successful, the speech recognition of everyday speech has the problem that speaking is frequently unclear, not in complete sentences or in colloquial language. The speech recognition of such uncooperative language makes extreme demands on speech recognition systems.

It is an object of the present invention to specify a method for speech recognition by means of which a good result is achieved even under adverse circumstances.

This object is achieved by a speech recognition method of the type initially mentioned in which, according to the invention, a recognition result from at least one other audio signal is included in the examination of one of the audio signals by the speech recognition algorithm.

In this context, the invention is based on the consideration that for the speech recognition of an utterance with an adequate recognition quality, it may be necessary, especially under disadvantageous boundary conditions, to use one or more recognition criteria, the results of which go beyond the recognition results which can be obtained from the utterance per se. For this purpose, information outside the actual utterance can be evaluated.

One such additional information item can be obtained from the assumption that in a conversation a single subject is pursued—at least over a certain period. As a rule, a subject is associated with a restricted vocabulary so that the speaker who speaks on this subject uses this vocabulary. If the vocabulary is known at least partially from some utterances, the words of this vocabulary can be assigned a greater probability of occurrence in the speech recognition of subsequent utterances. It is therefore helpful for the speech recognition of an utterance or of an audio signal obtained from the utterance to take into consideration a recognition result from preceding utterances which have already been examined by the speech recognition algorithm, the words of which are therefore known.

An utterance can be one or more characters, one or more words, a sentence or a part of a sentence. It is suitably examined as a unit by the speech recognition algorithm, that is to say, for example, segmented into a number of phonemes to which a number of words are assigned which form the utterance. However, it is also possible that an utterance is only a single sound which has been formulated by a speaker, for example as an integral statement, like a sound for a confirmation, a doubt or a feeling. If such a sound occurs more frequently within a number of further utterances, it can be identified again later as such a one after the examination of its first occurrence. In the case of a repeated identification, its semantic significance can be recognized more easily from its relationship with utterances surrounding it in time.

From each utterance, precisely one audio signal is suitably generated so that there is an unambiguous correlation of utterance and audio signal. The audio signal can be a continuous energy pulse or can represent such a one which has been obtained from the utterance. An audio signal can be segmented, for example, by means of a speech recognition algorithm and be examined for phonemes and/or words. The recognition result of the speech recognition algorithm can be obtained in the form of a character string, e.g. of a word, so that it is possible to infer a word of the utterance currently to be examined from the preceding and recognized words.

The speech recognition algorithm can be a computer program or a computer program part which is capable of recognizing a number of words, spoken in succession and in a context, in their context and outputting them as words or character strings.

An advantageous embodiment of the invention provides that the recognition result of the other audio signal is present as a character string and at least a part of the character string is included in the examination of the audio signal. If, for example, a list of candidates, formed by the speech recognition algorithm, comprising a number of candidates, e.g. words, is present, there can be a comparison between at least one of the candidates and previously recognized character strings. If a correspondence is found, a result value or plausibility value of the candidate concerned can be changed, e.g. increased.

Suitably, it is used as recognition result how frequently a character string, e.g., a word, occurs within the other audio signals. The more frequently a word occurs, the higher is the probability that it occurs again. The result value of a candidate which has already been recognized several times previously can be correspondingly changed in accordance with the frequency of its occurrence.

Before a list of candidates can be created, a segmentation of the audio signal to be examined must be carried out, e.g. into individual phonemes. In the case of indistinct speech, the segmentation already presents a large hurdle. To improve the segmentation, at least one segmentation from another audio signal can be used as recognition result. Audio signals already examined can be examined for characteristics, e.g. of vibrations which are similar in a predetermined manner to a characteristic of the audio signal to be examined. In the case of a similarity characteristic which is adequate in a predetermined manner, a segmentation result or segmentation characteristic—called segmentation in simplified manner in the text which follows, can be taken over.

With respect to a sequence in time of the audio signal to be examined from the other audio signals, any order is possible. The audio signal to be examined can belong to an utterance which has been made after the utterances which are allocated to the other audio signals, in time at least partially, particularly completely. However, it is also conceivable and advantageous if a doubtful segmentation or another recognition result of an audio signal is corrected due to a recognition result of a subsequent audio signal. If it is found, e.g. afterwards, that a candidate previously evaluated low in a candidate list occurs frequently and with high weighting later, the recognition of the earlier audio signal can be corrected.

It is also advantageous if, for the examination of the audio signal, recognition results from the other audio signals are examined for criteria which depend on a characteristic of the audio signal to be examined. Thus, e.g. a search for words having similar tonal characteristics can take place in order to recognize a word of the audio signal to be examined.

It is appropriate, particularly in the case of a dialog between two speakers, to divide the audio signals into at least one first and one second train of speech with the aid of a predetermined criterion, with the first train of speech being allocated suitably to the first speaker and the second train of speech being allocated to the second speaker. In this manner, the first speaker can be assigned the audio signal to be examined and the second speaker can be assigned the other audio signals. The trains of speech can be channels so that a channel is allocated to each speaker during the conversation—and thus to all his utterances. This procedure has the advantage that largely independent recognition results are included in the examination of the audio signal to be examined. Thus, a word which is spoken by one of the speakers can be easily recognized, whereas the same word, spoken by the second speaker, can be regularly recognized badly. If it is known that the first speaker frequently uses one word, the probability is high that the second speaker also uses the word even if it only achieves a poor result in a candidate list.

In a particularly reliable manner, the assignment of the audio signals to the speakers can be obtained by means of criteria lying outside the speech recognition. Thus, the pickup system has two of the more speech receivers, namely one microphone each in each of the telephones used in a telephone conversation so that the audio signals can be allocated reliably to the speakers.

If, for example, there are no reliable criteria lying outside the speech recognition, the assignment of the audio signals can be effected by means of tonal criteria with the aid of the speech recognition algorithm.

A further variant of an embodiment of the invention provides that the recognition result from the other audio signals is weighted in accordance with a predetermined criterion and its inclusion in the examination of the audio signal to be examined is performed in dependence on the weighting. Thus, the criterion can be, e.g., a time relationship between the audio signal to be examined and the other audio signals. A recognition result of an utterance which is close to those to be examined in time can be weighted more highly than a recognition result dating back in time.

It is also possible and advantageous if the criterion is a content relationship between the audio signal to be examined and the other audio signals. The content relationship can be a semantic relationship between the utterances, e.g. an identical meaning or similar meaning of a candidate with a word previously recognized frequently.

A further advantageous criterion is an intonation in one of the audio signals. If an utterance is spoken with particular pathos, an audio signal, for which a similar pathos was recognized, can be compared particularly thoroughly with the recognition result of the pathetic utterance. The intonation can be present in the audio signal to be examined and/or the other audio signals.

In addition, the invention is directed towards a speech recognition device with a pickup system, a storage medium in which a speech recognition algorithm is stored, and a process means which has access to the storage medium and which is prepared to obtain a number of audio signals from a speech input of several utterances of at least one speaker and to examine the audio signals with the speech recognition algorithm and to obtain a recognition result for each audio signal.

It is proposed that the speech recognition algorithm, according to the invention, is designed for including a recognition result from at least one other audio signal during the examination of one of the audio signals.

The invention will be explained in greater detail with reference to exemplary embodiments which are shown in the drawings, in which:

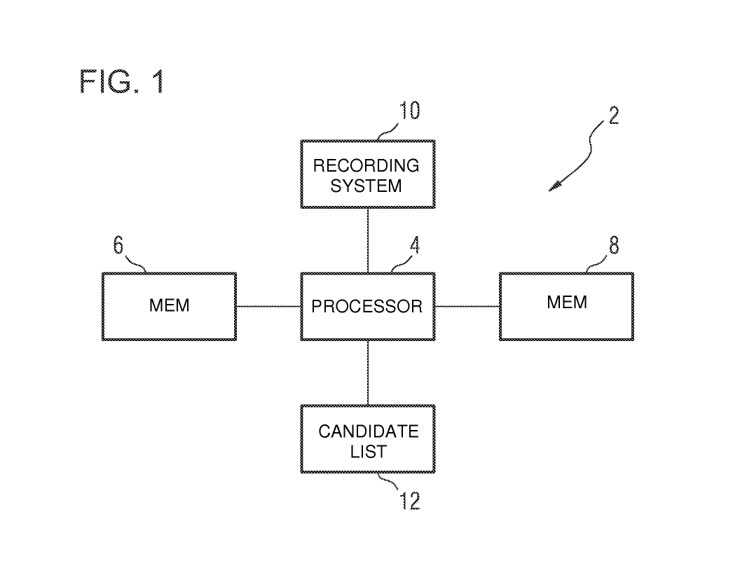

FIG. 1 shows a diagram of a speech recognition device comprising a process means and data memories,

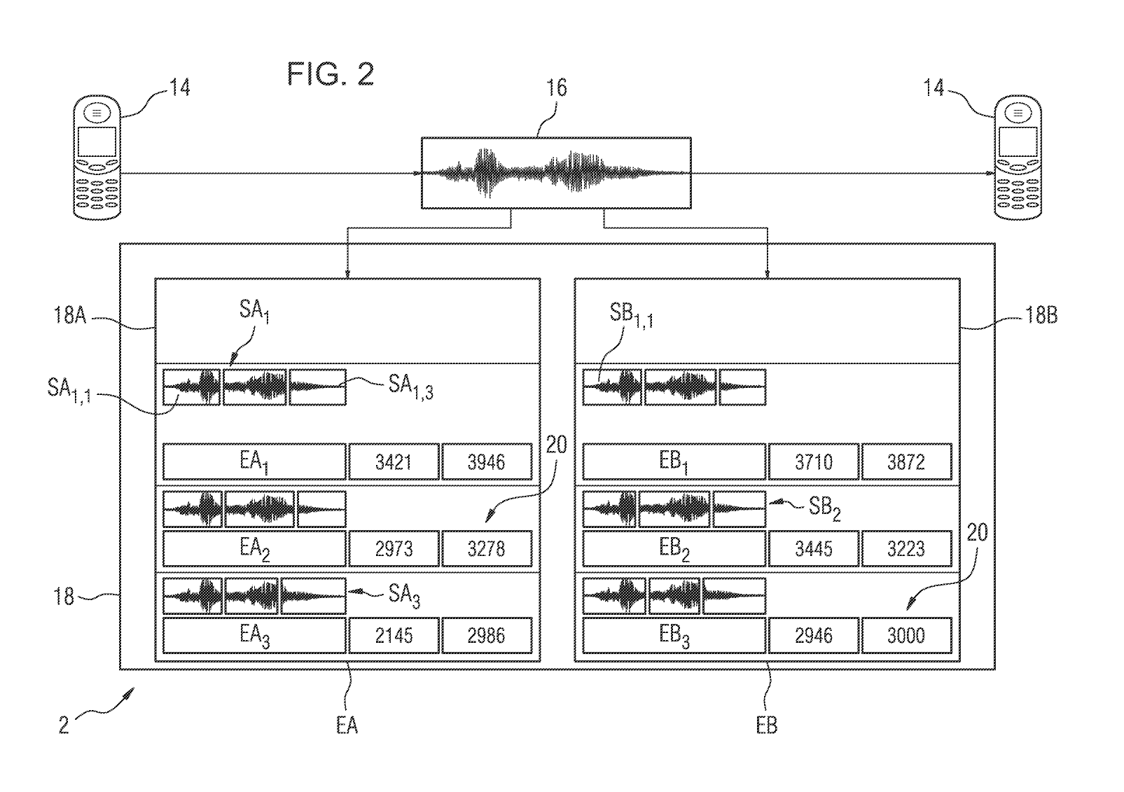

FIG. 2 shows an overview diagram which represents the segmentation of an utterance by two speech recognition devices,

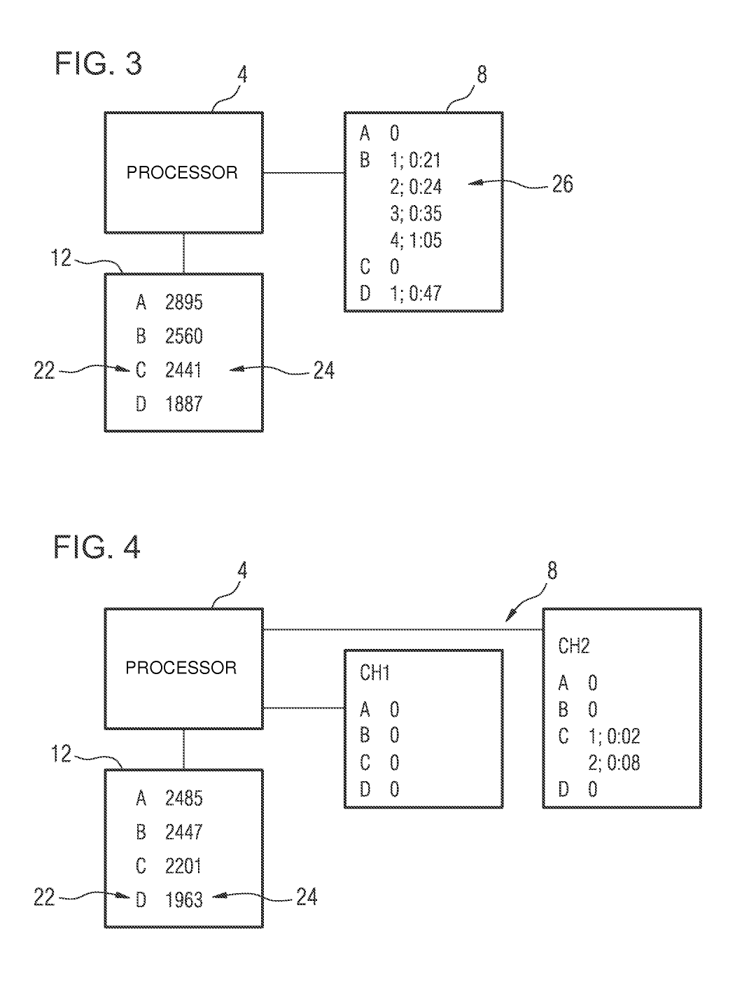

FIG. 3 shows a diagram of a list of candidates and of a comparison list of previously recognized words,

FIG. 4 shows a diagram of a list of candidates and two comparison lists from different speech channels,

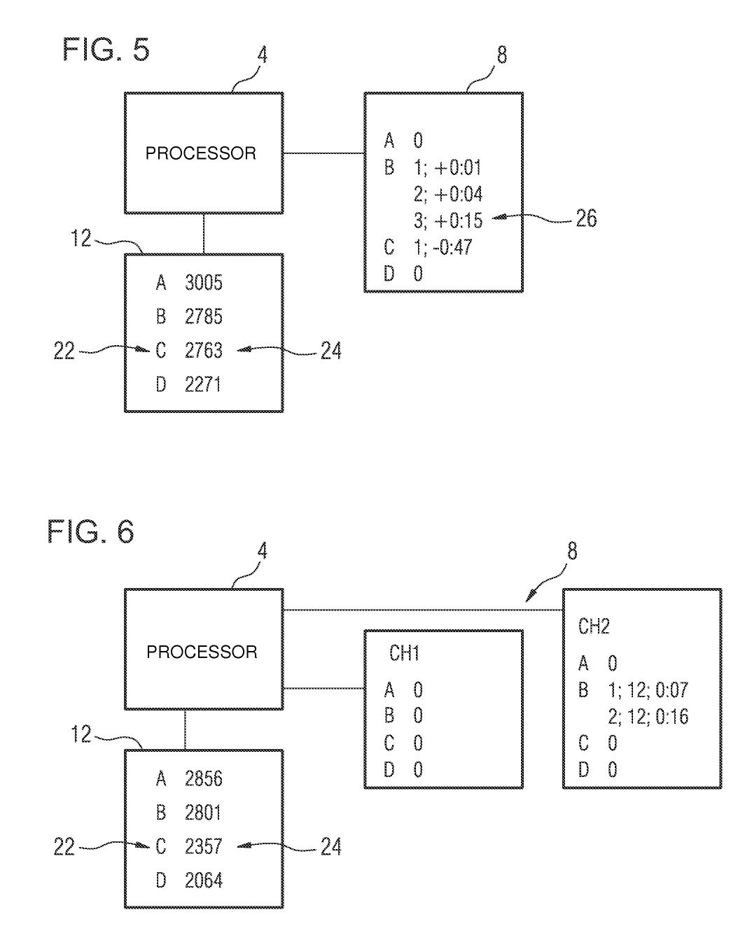

FIG. 5 shows a diagram for representing a subsequent correction of candidate evaluations of a list of candidates, and

FIG. 6 shows a diagram with a comparison list containing synonyms.

FIG. 1 shows a greatly simplified representation of a speech recognition device 2 with a process means 4, two storage media 6, 8 and a pickup system 10. The storage medium 6 contains a speech recognition algorithm in the form of a data processing program which can contain a number of subalgorithms, e.g. a segmenting algorithm, a word recognition algorithm and a sentence recognition algorithm. The storage medium 8 contains a database in which recognition results of the speech recognition performed by the process means 4 are deposited such as audio signals, segmentations, recognized characters, words and word sequences.

The pickup system 10 comprises one or more microphones for picking up and recording utterances by one or more speakers. The utterances are converted into analog or binary audio signals by the process means 4 which is connected to the pickup system 10 by means of a data transmission link. A flowing stream of speech is converted into a plurality of audio signals by the process means 4, the conversion being affected in accordance with predetermined criteria, e.g. in accordance with permissible length ranges of the audio signals, speech pauses and the like. From the audio signals, the process means 4 generates for each determined word or for word sequences of the utterances in each case one list of candidates 12 of possible word candidates or word sequence candidates.

FIG. 2 shows an exemplary embodiment in which utterances by two speakers telephoning one another are supplied to the speech recognition device 2. Correspondingly, the pickup system 10 comprises two mobile telephones 14, e.g. in different countries, one of the speakers speaking into one and the other speaker speaking into the other mobile telephone 14. Each of the mobile telephones 14 converts the utterances of its speaker into audio signals which are supplied later to the process means 4, not shown in FIG. 2, directly or in the form of a recording. The process means 4 uses the audio signals directly or converts them into other audio signals 16 more suitable for the speech recognition, one of which is shown diagrammatically in FIG. 2.

The audio signal 16 is supplied to a speech recognition system 18 which consists of two speech recognition units 18A, 18B. The audio signal 14 is here supplied to each of the speech recognition units 18A, 18B in identical form so that it is processed by the speech recognition units 18A, 18B independently of one another. The two speech recognition units 18A, 18B work here in accordance with different speech recognition algorithms which are based on different processing or analysis methods. The speech recognition units 18A, 18B are thus different products which can be developed by different companies. Both of them are units for recognizing continuous speech and contain in each case a segmenting algorithm, a word recognition algorithm and a sentence recognition algorithm which operate in a number of method steps built up on one another. The algorithms are part of the speech recognition algorithm.

In one method step, the audio signal 16 is examined for successively following word or phoneme components and is correspondingly segmented. In a segmenting method, the segmenting algorithm compares predefined phonemes with energy modulations and frequency characteristics of the audio signal 16. In this processing of the audio signal 16 and the allocating of phonemes to signal sequences, the sentence recognition algorithm assembles phoneme chains which are iteratively compared with vocabulary entries in one or more dictionaries which are deposited in the storage medium 6 in order to find possible words which thus specify segment boundaries in the continuum of the audio signal 16 so that the segmentation takes place as a result. As a result, the segmentation already contains a word recognition with the aid of which the segmenting takes place.

The segmenting is performed by each speech recognition unit 18A, 18B separately and independently of the in each case other speech recognition unit 18B, 18A. In this context, the speech recognition unit 18A, like the speech recognition unit 18B—forms a multiplicity of possible segmentations SAᵢ which are in each case provided with a result value 20. The result value 20 is a measure of the probability of a correct result. The result values 20 are standardized, as a rule, since the different speech recognition units 18A, 18B use a different range for their result values 20. The result values 20 are shown standardized in the figures.

The segmentations SAᵢ having the highest result values 20 are combined in a list of candidates EA which contains a number of candidates EAᵢ. In the exemplary embodiment shown, each speech recognition unit 18A, 18B in each case generates a list of candidates EA and EB, respectively, having in each case three candidates. Each candidate EAᵢ is based on a segmentation SAᵢ and SBᵢ, respectively, so that six candidates having six—possibly different—segmentations SAᵢ, SBᵢ present as a result. Each candidate contains, in addition to the result value 20, a result which is built up of character strings which can be words. These words are formed in the segmenting method.

In each segmentation SAᵢ, SBᵢ, the audio signal 16 is divided into a number of segments SA_{i,i}, SB_{i,i}. In the exemplary embodiment shown in FIG. 2, the segmentations SAᵢ, SBᵢ are mostly three segments SA_{i,i}, SB_{i,i}. However, it is possible that the segmentations exhibit even greater differences.

The results of the segmentation are word strings of a number of words which can be processed subsequently by means of hidden Markov processes, multi-gram statistics, grammatic tests and the like until finally a list of candidates 12 with a number of possible candidates 22 is generated as a result for, for example, each audio signal. Such lists of candidates 22 are shown in FIG. 3 to FIG. 6. In the exemplary embodiments shown, the list of candidates 22 contain in each case four candidates 22, candidate lists having more or fewer candidates also being possible and appropriate. Each candidate 22 is assigned a result value 24 which reproduces a calculated probability of the agreement of the candidate 22 with the uttering allocated. The highest result value 24 reproduces the highest probability of the correct speech recognition of the utterance. The candidates 22 form in each case a recognition result of the speech recognition and can be in each case a phoneme, a word, a word string, a sentence or the like. The result values 24 in each case form a recognition result.

FIG. 3 shows a first exemplary embodiment of the invention in which the process means 4 has generated from an audio signal 16 of an utterance within a conversation of two speakers a list of candidates 12 with four candidates 22, the result value 24 of which are all below a threshold value, for example below 3000. The probability of the correct speech recognition may thus not be sufficiently high. This triggers one or more method steps which are described for FIG. 3 to FIG. 6, wherein these method steps can also be performed always additionally to the speech recognition described above, that is to say even when a result value of at least the best candidate 22 is above the threshold value.

Such a method step signifies that the database of the storage medium 8 is examined to see whether it has entries corresponding to the candidates 22 of the list of candidates 12. If, for example, a word has already been spoken once or several times in the conversation, it is deposited in the database as a recognition result, in this case as candidate considered to be correct of previously examined audio signals—in each case, correct speech recognition of the word is required. Each recognition result is provided with time information 26 which can relate to a predetermined initial time, e.g. the start of the conversation or the time interval of the audio signal currently to be examined, the time information then being variable.

In the exemplary embodiment shown, no previous speech recognition result is found for candidate A having the highest result value 24, four for candidate B, none for candidate C and an earlier recognition result for candidate D. The earlier recognition results are 21 seconds, 24 seconds etc. before the beginning of recording of the utterance of the audio signal 16 to be examined.

Taking note of the earlier recognition results, a certain probability is obtained that candidate B is the correct candidate since it has already been mentioned several times in the conversation. This additional probability is mathematically calculated, e.g., added, together with the result value 24 of the candidate B so that the total result of the candidate B may lie above the threshold value and is evaluated as being acceptable. In the calculation of the probability of a candidate 22, the result value of the words recognized earlier can be included. If a word recognized earlier has a high probability value, it has presumably been recognized as being correct so that a correspondence with the corresponding candidate 22 is a good indication for the correctness of candidate 22.

The use of the hits found can be weighted by means of the time information 26. Thus, for example, the weighting is such that the greater the time, the less is the weighting since a temporal proximity of hits in the database increases the probability of the correctness of a candidate 22.

A further or additional option is shown in FIG. 4. The conversation is divided into two trains of speech, in the present exemplary embodiment two channels CH1, CH2, the utterances of one speaker being assigned one channel CH1 and the utterances of the other speaker being assigned the other channel CH2. The channel assignment is simple in this case since it is performed by the mobile telephones which pick up the utterances separately. In other cases, a sound characteristic of the utterances can be used for the division into the trains of speech, e.g. an accent or a pitch so that several speakers can be distinguished.

As described with reference to FIG. 3, the candidates 22 are checked for their presence in the database. The candidates 22 have been determined from an utterance of the speaker to whom channel CH1 was assigned. This speaker has mentioned the word belonging to the candidate 22 for the first time in the conversation, it does not appear in the database of the first channel assigned to him. However, candidate C appears twice among the words used by the other speaker, namely two and eight seconds before the first speaker has pronounced the word reproduced by the candidate C. The presence of this word in the second channel, especially with a very short time interval of a few seconds, is a strong indication that the speaker of channel CH1 has repeated or also used the word which appeared briefly before in channel CH2. The probabilities are allocated accordingly as explained with reference to FIG. 3.

If one of the candidates 22, e.g. candidate A, should also be present in channel CH1 or its database or database section, respectively, the results from both channels CH1, CH2 are in conflict with one another. In this case, the fact of which channel a candidate 22 was mentioned in previously is also of significance, apart from the time information. In this context, the train of speech or channel can be given a lower weighting which belongs to the speaker whose audio signal is to be examined. The other train or trains of speech or channels, in the exemplary embodiment channels CH2, are given a higher weighting. This procedure is based on the experience that a word of a speaker which is poorly recognized is previously probably also poorly understood which is why the error rate of a wrong recognition is higher. The use of information from the same channel thus increases the risk of rendering single errors into systematic errors. The information from the other channel or channels, in contrast, is independent information which does not increase the error probability.

FIG. 5 shows an exemplary embodiment in which a word is subsequently corrected. If, for example, the method from FIG. 3 or from FIG. 4 does not provide any ongoing and probability-increasing information, the audio signal 16 can be supplied again to the speech recognition algorithm later. The database can now be examined not only for utterances preceding with respect to candidates 22 but repetitions can also be taken into consideration.

FIG. 5 shows that the word of candidate B was mentioned again one second later and a second and third time after four and 15 seconds. Candidate C was pronounced 47 seconds before. This result increases the probability for candidate B distinctly since it can be assumed that the word allocated to him was mentioned several times in brief succession. The hit for candidate C is not used since it is too far remote in time from the audio signal 16 to be examined.

An inclusion of synonyms is shown in FIG. 6. The database from the storage medium 8 contains here a list of synonyms for a multiplicity of words. The synonyms can be found in a simple thesaurus process, that is to say conventional words of identical or similar significance in a language are searched for. An expansion of this method step includes that colloquial synonyms are also listed, for example dough, scratch, green for “money”. A further supplement includes those words which are known appropriately from technical circles, that is to say do not belong to the general vocabulary but are only known in the individual technical circles, in which context dictionaries of synonyms from obscure “technical circles” can also be used. A further extension provides that dialect synonyms are used, that is to say words from different dialects of a language which have identical or similar meaning as the original word for which the synonyms are searched for.

In FIG. 6, two entries are found which were used seven and 16 seconds before, including the synonyms for candidate B. Since the same word is in each case behind the synonyms, that is to say the same word or synonym was found twice, a similarity value specified with the central number, the number 12 in this case, is the same for both words which were found and are equal. If different synonyms are found, the similarity value can provide information on how close—and thus how probable—the synonyms are with respect to the candidate to be tested. In this exemplary embodiment, too, the hits in the database increase the probability of recognition of the relevant candidate, in this case candidate B.

As an alternative or additionally to the comparisons of words or character strings described here, it is advantageous especially in the case of a two-channel evaluation to evaluate another criterion of an audio signal, e.g. an intonation of an audio signal. In this context, there are a number of options which can be performed alternatively or jointly. Firstly, the intonation of the audio signal to be examined can be evaluated, that is to say of the audio signal from which the list of candidates was generated. An intonation which can comprise one or more of the parameters pitch, loudness, increased noisiness, e.g. due to a throaty speech, and fluctuations or changes of these parameters, can provide information about the content of a word, e.g. the use of a synonym for avoiding a term to be kept secret.

Whilst the intonation of the speaker can be monitored naturally for additional information for speech recognition, the monitoring of the other train of speech or channel has the advantage that information independent of the speaker can be obtained. This is because, when a speaker does not supply any additional indications due to monotonous speaking, his conversational partner may well provide intonation information, especially with respect to the utterances which are located shortly before or after the time of occurrence of the intonation information.

Furthermore, a content-related relationship between the audio signal to be examined and the other audio signals can be examined and used for weighting purposes. If, for example, a direct semantic relationship between two trains of speech has been recognized—this can be effected by a degree of identity of the vocabulary used—it can be assumed with a higher probability that hits from the other train of speech increase the probability of a candidate.

Depending on the characteristic of the audio signal 16 to be examined, the recognition results of the remaining audio signals, that is to say the database, can be examined for one or more criteria. On the occurrence, e.g., of a particular intonation, recognition results with a similar intonation can be examined, on occurrence of characteristic pauses between words, corresponding audio signals, and so on.

The embodiments described can be used individually or in any arbitrary combination with one another. Correspondingly, there are in each case a number of result values available for one or a number of candidates 22. The concluding probability for a candidate or a word combination of a number of candidates 22 which is allocated to the audio signal 14 can be a function of these result values or probabilities, respectively. The simplest function is the addition of the individual result values.

In accordance with the exemplary embodiments described before, a database inquiry can be performed with respect to other results obtained from an audio signal. If, for example, a segmentation has a poor segmentation result so that a segmentation is difficult to perform, it is possible to search for similar audio signals, especially in the other train of speech or in other trains of speech which can provide information about a correct segmentation. Correspondingly, the candidates 22 can be not a word or a character string but other results from the audio signal such as, e.g., a segmentation parameter or the like.

### LIST OF REFERENCE SYMBOLS

2 Speech recognition device
4 Process means
6 Storage medium
8 Storage medium
10 Pickup system
12 List of candidates
14 Mobile telephone
16 Audio signal
18 Speech recognition system
20 Result value
22 Candidate
24 Result value
26 Time information
EA List of results
EAᵢ Result
EB List of results
EBᵢ Result
SAᵢ Segmentation
SA_{i,i} Segment
SBᵢ Segmentation
SB_{i,i} Segment

1-14. (canceled)

15. A speech recognition method, comprising:
acquiring a plurality of audio signals from a voice input including a plurality of utterances of at least one speaker into a pickup system;
examining the audio signals using a speech recognition algorithm to obtain a recognition result for each of the audio signals; and
including in the examination of one of the audio signals by the speech recognition algorithm, a recognition result from at least one other audio signal.

16. The speech recognition method according to claim 15, wherein the recognition result of the at least one other audio signal is present as a character string, and the including step comprises including at least a part of the character string in the examination of the audio signal.

17. The speech recognition method according to claim 15, which comprises using a frequency of occurrence of a character string within the other audio signals as recognition result.

18. The speech recognition method according to claim 15, which comprises using at least one segmentation from another audio signal as recognition result.

19. The speech recognition method according to claim 15, wherein the audio signal to be examined lies at least partially behind the other audio signals in time.

20. The speech recognition method according to claim 15, which comprises, for the examination of the audio signal, examining recognition results from the other audio signals for criteria that depend on a characteristic of the audio signal to be examined.

21. The speech recognition method according to claim 15, wherein the utterances originate from a first speaker and a second speaker, and the first speaker is assigned the audio signal to be examined and the second speaker is assigned the other audio signals.

22. The speech recognition method according to claim 21, which comprises obtaining an assignment of the audio signals to the first and second speakers by way of criteria lying outside the speech recognition.

23. The speech recognition method according to claim 21, which comprises assigning the audio signals to the first and second speakers based on tonal criteria obtained by the speech recognition algorithm.

24. The speech recognition method according to claim 15, which comprises weighting the recognition result from the other audio signals in accordance with a predetermined criterion and including the recognition result in the examination of the audio signal to be examined in dependence on the weighting.

25. The speech recognition method according to claim 24, wherein the predetermined criterion is a time relationship between the audio signal to be examined and the other audio signals.

26. The speech recognition method according to claim 24, wherein the predetermined criterion is a content-related relationship between the audio signal to be examined and the other audio signals.

27. The speech recognition method according to claim 24, wherein the predetermined criterion is an intonation in one of the audio signals.

28. A speech recognition device, comprising:
a recording pickup system;
a storage medium having stored thereon a speech recognition algorithm;
a processor device connected to said storage medium for loading the speech recognition algorithm into a working memory thereof, said processor device being programmed to:
obtain a plurality of audio signals from a voice input of a number of utterances of at least one speaker;
to examine the audio signals with the speech recognition algorithm and to obtain a recognition result for each audio signal; and
wherein the speech recognition algorithm is configured, when being processed in said processor device, for including a recognition result from at least one other audio signal during the examination of one of the audio signals.
